(19) United States
(12) Patent Application Publication
(10) Pub. No.: US 2012/0103233 A1
(43) Pub. Date: May 3, 2012

(54) BUILDING SEGMENT, IN PARTICULAR OF BOARD SHAPE AND THE METHOD OF MANUFACTURING THEREOF

(76) Inventors: Juraj Plesnik, Myjava (SK); Josef Zlámala, Dubravka (SK)

(21) Appl. No.: 13/378,077

(22) PCT Filed: Sep. 21, 2009
(86) PCT No.: PCT/SK2009/050011

§ 371 Date: Dec. 14, 2011

(30) Foreign Application Priority Data
Jun. 16, 2009 (SK) PP 50032-2009

(51) Int. Cl. C04B 11/00; C08L 75/04

(52) U.S. Cl. 106/778; 106/772; 524/590

(57) ABSTRACT

Building segment, in particular of board shape, comprises of mixture of basic component with admixture, comprising of recycled material from textile fibres acquired by defibering process from hardly defiberable multi-composite textiles, which can be supplemented by recycled material from textile pulp acquired by the process of tyres recycling. Basic components advantageously comprises of plaster or polyurethane. During manufacturing of this building segment, textile waste is defibred to textile fibres, which are processed to required length and are homogenized into even layer, and then it is added to the mixture of basic component containing other components.

### TECHNICAL FIELD

The present invention relates to building segments, in particular of board shape comprising of basic component or mixture of basic component and admixture of recycled material.

### BACKGROUND ART

Building segments known in the present time, in particular of board shape, are formed by basic component, comprising in particular of polyurethane or plaster, or mixture of plaster with admixture of glass fibres or recycled paper. In the known method of production, admixtures are added to basic component during dry process by admixing.

Disadvantage of these segments is low degree of their thermal and sound-proofing insulation, while high homogeneity thereof at adding admixtures is required in the technological process of manufacturing for improving physical and mechanical characteristics, which is difficult to achieve.

Recycled material from short textile fibres acquired by defibering process from hardly defiberable multi-composite textiles and recycled material from textile pulp acquired by the process of tyres recycling is not further processed in the present time and represents unusable waste. Mentioned types of textile recycled materials are produces nowadays in great quantities and final products, where utilizing thereof would be possible, are not known, while disposal thereof burdens the environment.

### DISCLOSURE OF INVENTION

Mentioned disadvantages are eliminated to the substantial degree by building segment, in particular of board shape, comprising of basic component or mixture of basic component with admixtures, according to this invention, the substance whereof resides in that admixture comprises of recycled material from textile fibres acquired by defibering process from hardly defiberable multi-composite textiles.

The admixture is advantageously supplemented by recycled material from textile pulp acquired by process of tyres recycling.

Basic component advantageously comprises of plaster and admixture of recycled material is contained in the amount of 30% of weight.

Basic component advantageously comprises of polyurethane and admixture of recycled material is contained in the amount of 75% of weight.

The length of used textile fibres does not exceed 25 mm.

During the method of manufacturing building segment, in particular of board shape, textile waste from hardly defiberable multi-composite textiles is defibred into textile fibres, which are processed to the length of max. 25 mm and are homogenized into even layer, and then it is added to the mixture of basic component containing other components.

Textile fibres, upon modifying of length thereof and prior to homogenization, are advantageously mixed with recycled material from textile pulp acquired by the process of tyres recycling.

Adding of textile fibres into basic component is advantageously carried out by mechanical admixing or pouring layer thereof without mechanical admixing, while basic component advantageously comprises of plaster or polyurethane.

During production of building segments manufactured according to this composition, industrial waste from manufacturing, as well as the waste occurring after the end of original product life-time, where hardly defiberable textile or textile from tyres were used, are advantageously utilized. New product with long life time and better construction and sound-proofing and thermal insulation characteristics is produced, which does not bear an environmental burden.

### MODE(S) FOR CARRYING OUT THE INVENTION

### Mode 1

Constructional building segment of board shape comprises of mixture of basic component—plaster and admixture, comprising of recycled material from textile fibres acquired by defibering process from hardly defiberable multi-composite textiles. Textile fibres are processed to the length up to 25 mm. The plaster is contained in the mixture in the amount of 75% and recycled material of 25% of weight.

During manufacturing of this constructional building segment, the textile waste from hardly defiberable multi-composite textiles is defibred to textile fibres by means of defibering machine. Then textile fibres are processed to maximum length of 25 mm and are homogenized into even layer. In the next step, they are added by mechanical admixing to liquid mixture of basic component—plaster, enriched by other components and this mixture is then formed by standard technological procedure into required shape of board and is hardened.

### Mode 2

Insulation building segment of board shape is formed by basic component—polyurethane and admixture, which is formed by mixture comprising of textile fibres acquired by defibering process of hardly defiberable multi-composite textiles and textile pulp acquired by the process of tyres recycling. Textile fibres are processed to the length up to 25 mm. The polyurethane is contained in the mixture in the amount of 30% and recycled material mixture of 70% of weight.

During manufacturing of this insulation building segment, the textile waste from hardly defiberable multi-composite textiles is defibred to textile fibres by means of defibering machine. Then textile fibres are processed to the maximum length of 25 mm. Subsequently, textile pulp acquired by the process of tyres recycling is added to these textile fibres and they are homogenized into even layer. In the next step, they are added by pouring in the form of full-area layer without mechanical admixing to liquid mixture of basic component—polyurethane, which is incorporated gradually wherein and then it is formed by standard technological procedure into required shape of board and is hardened.

1. A building segment, in particular of board shape, comprising:
a mixture comprising a basic component selected from the list of: plaster and polyurethane; and
an admixture comprising recycled material; wherein the recycled material is acquired by a defibering process of woven or nonwoven fabric containing synthetic and/or natural fibres and other organic and/or inorganic admixtures.

2. The building segment according to claim 1 wherein the recycled material is supplemented by recycled material from textile pulp acquired by the process of tyres recycling.

3. The building segment according to the claim 1 wherein the amount of admixture contained in the mixture is 30% by weight.

4. The building segment according to claim 1 wherein the basic component is polyurethane and the amount of admixture contained in the mixture is 75% by weight.

5. The building segment according to claim 1 wherein the length of textile fibres does not exceed 25 mm.

6. A method of manufacturing a building segment, such as a board shape, comprising the steps of: processing textile waste from woven or nonwoven fabric containing synthetic and/or natural fibres and other organic and/or inorganic admixtures difibred into textile fibres, which are processed to a maximum length of 25 mm; homogenizing the textile fibres into an even layer, and adding the textile fibres to a mixture comprising a basic component selected from the list of plaster and polyurethane.

7. The method of manufacturing according to claim 6 wherein the textile fibres, upon modifying of length thereof and prior to homogenization, are mixed with recycled material from textile pulp acquired by the process of tyres recycling.

8. The method of manufacturing according to claim 6 wherein the step of adding the textile fibres into the basic component is carried out by mechanical admixing.

9. The method of manufacturing according to claim 6 wherein the step of adding the textile fibres into the basic component is carried out by pouring a layer thereof without mechanical admixing.

10. (canceled)

11. The building segment according to the claim 2, wherein the amount of admixture contained in the mixture is 30% by weight.

12. The building segment according to claim 2, wherein the basic component is polyurethane and the amount of admixture contained in the mixture is 75% by weight.

13. The building segment according to claim 2, wherein the length of textile fibres does not exceed 25 mm.

14. The building segment according to claim 3, wherein the length of the textile fibres does not exceed 25 mm.

15. The building segment according to claim 4, wherein the length of the textile fibres does not exceed 25 mm.

16. The method of manufacturing according to claim 7, wherein the step of adding the textile fibres into the basic component is carried out by mechanical admixing.

17. The method of manufacturing according to claim 7, wherein the step of adding the textile fibres into the basic component is carried out by pouring a layer thereof without mechanical admixing.
